(19) United States
(12) Patent Application Publication
(10) Pub. No.: US 2024/0070609 A1
(43) Pub. Date: Feb. 29, 2024

(54) GENERATING AND PROVIDING NOTIFICATIONS AND INDICATIONS IDENTIFYING ITEMS THAT ARE LIKELY TO BE RESTOCKED

(71) Applicant: Maplebear Inc. (dba Instacart), San Francisco, CA (US)

(72) Inventors: Nicholas Petrielli, Vancouver (CA); Richard Bartholomew, Chicago, IL (US); Vinay Nagar, Danville, CA (US); Chaman Thapa, San Francisco, CA (US)

(21) Appl. No.: 17/893,940

(22) Filed: Aug. 23, 2022

(51) Int. Cl. G06Q 10/08

(52) U.S. Cl. CPC G06Q 10/087; G06Q 10/0833; G06Q 10/08355

(57) ABSTRACT

An online concierge system facilitates procurement and delivery of items for customers using a network of shoppers. The online concierge system includes a restocking management engine that obtains restocking information associated with unavailable items and delivers relevant notifications to customers and/or retailers relevant to restocking information. Responsive to an item availability model predicting an item will be unavailable at a requested order fulfillment time, the online concierge system obtains item tracking information and determines if the item will be restocked within a predefined time period. If the item is expected to be restocked in the near future, the online concierge system may present a notification to a customer application enabling the customer to change the order fulfillment time to a later time when the item is expected to be available.

### BACKGROUND

This disclosure relates generally to an online concierge system for managing procurement and delivery of items to customers and more specifically to computer hardware and software for generating and presenting notifications relating to restocking of items.

In an online concierge system that facilitates procurement and delivery of items to customers from physical retailers, it is helpful to have accurate visibility into the availability of specific items from different retailers. Failing to recognize the unavailability of an item when accepting an order can result in orders going unfulfilled or being significantly delayed, thereby causing significant dissatisfaction from both the customer and the shopper. On the other hand, incorrectly identifying an item as unavailable can lead to lost sales opportunities and may further result in customer dissatisfaction.

### SUMMARY

In accordance with one or more aspects of the disclosure, an online concierge system obtains an item availability model trained to predict availability likelihoods of items in an inventory. A query is received from a customer via a customer application for an item at a requested order fulfillment time. The online concierge system predicts, based on the item availability model, whether or not the item will be available at the requested order fulfillment time in response to the query. Responsive to predicting that the item will not be available at the requested order fulfillment time, item tracking information is obtained indicating status of items enroute to retailers. The online concierge system determines, based on the item tracking information, if the item will be restocked at a future time within a predefined time period of the order fulfillment time. Responsive to determining that the item will be restocked at the future time, the online concierge system presents a notification via the customer application in response to the query indicating that the item will be restocked at the future time and enabling the customer to order the item for the future time. For example, the notification may provide an option to delay the order fulfillment time until the future time when the item will be restocked. The order fulfillment process is then delayed in response to the customer selecting the option via the customer application. At an appropriate time, the order is assigned to an available shopper and routing instructions are generated via a shopper application for facilitating delivery by the shopper to the customer.

In some embodiments, obtaining the item tracking information comprises obtaining at least one of: order information from the retailers indicative of items ordered from the retailers, delivery vehicle tracking data indicating tracked locations of delivery vehicles carrying the items ordered from the retailers, delivery vehicle routing data indicating planned routes of the delivery vehicles to the retailers, scanning data indicating times and locations where items have been scanned enroute to the retailers, and a restocking time model indicative of time between arrival of the items by the delivery vehicles and restocking of the items by the retailers.

In some embodiments, the online concierge system furthermore tracks a set of orders for a retailer associated with items predicted to be unavailable, and generates a notification to the retailer indicative of the tracked set of orders. Here, the notification to the retailer may comprise generating a recommendation for how to prioritize unloading and restocking of items based on the tracked set of orders, generating a recommendation to set aside one or more of the items for pickup without putting the items on shelves based on the tracked set of orders, and/or generating an audit report indicating whether the item tracking data is consistent with order information from one or more retailers.

### BRIEF DESCRIPTION OF THE DRAWINGS

FIG. 1 is a block diagram of a system environment in which an online system, such an online concierge system, operates, according to one or more embodiments.

FIG. 2 illustrates an environment of an online shopping concierge service, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 is a block diagram of a restocking management engine, according to one or more embodiments.

FIG. 6 is a flowchart illustrating an example embodiment of a process for providing notifications relating to restocking of items in the context of fulfilling an order through an online concierge system.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

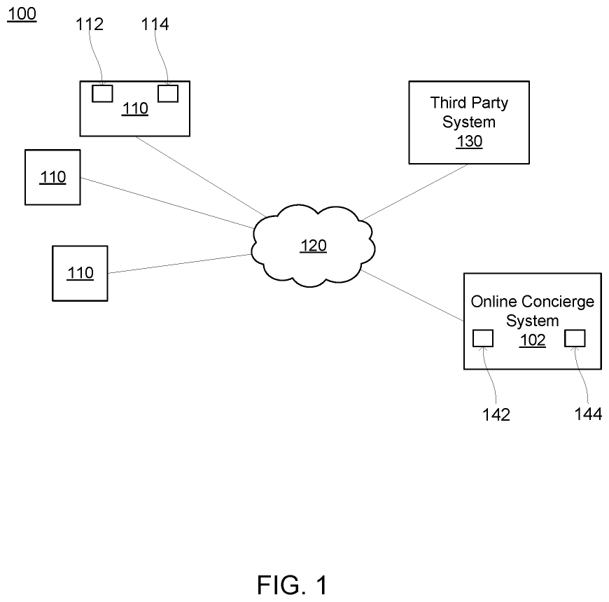

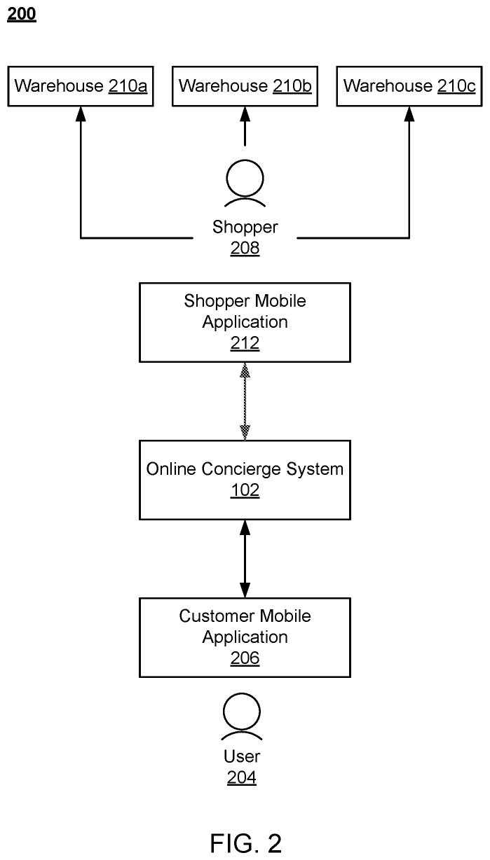

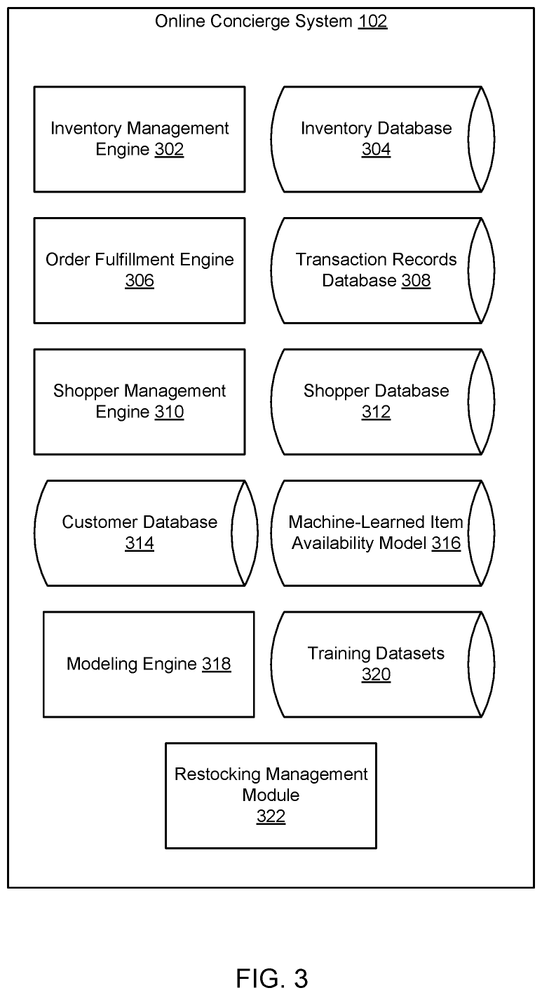

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

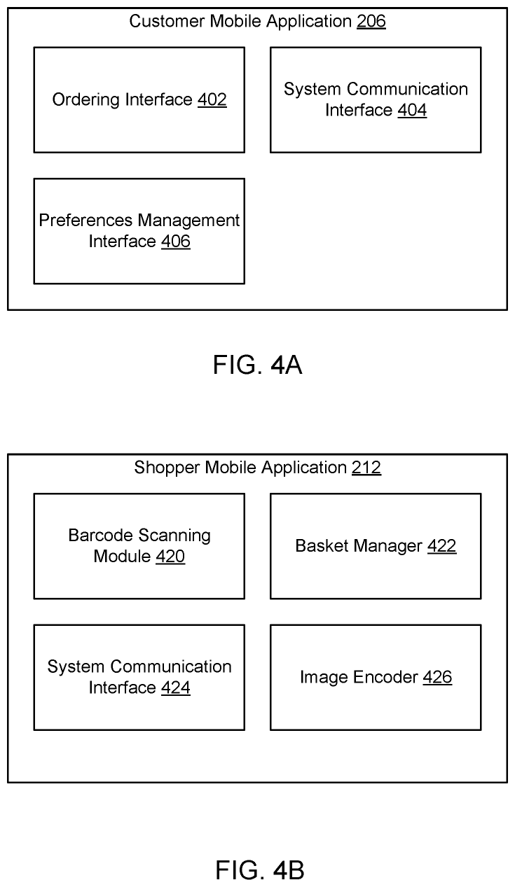

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described herein in relation to FIGS. 2-6. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of an online platform, such as an online concierge system 102, according to one or more embodiments. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered (e.g., based around an order fulfillment time). In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 202. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one embodiment, shoppers 208 make use of a shopper mobile application 212 which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

The inventory database 304 may also include information relating to restocking of items. For example, the inventory database 304 may store data relating to reordering of items, enroute tracking of reordered items, expected delivery time of items to the warehouses, timing associated with the restocking of items from the delivery vehicles to the shelves, or other information relevant to restocking of items at the warehouses. Specific features of the online concierge system 102 relating to restocking of items is discussed in further detail below with respect to the restocking management engine 322.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which items are available at which warehouse 210. The order fulfillment engine 306 may supplement the item availability information from the inventory database 234 with an item availability predicted by the machine-learned item availability model 316 and/or with restocking information from the restocking management engine 322. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 106. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, restocking information, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

In various embodiments, the order fulfillment engine 306 determines whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine-learned item availability model 316 may be any machine learning model, such as a neural network, boosted tree, gradient boosted tree, or random forest model. In some examples, the machine-learned item availability model 316 is generated from XGBoost algorithm. The item probability generated by the machine-learned item availability model 316 may be used to determine instructions delivered to the user 204 and/or shopper 208.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Factors relating to restocking may be further influenced by the restocking management engine 322 described in further detail below. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include an item type associated with the item. For example, if the item is a particular brand of an item, then the item type will be a generic description of the item type, such as “milk” or “eggs.” The item type may affect the item availability, since certain item types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the item is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

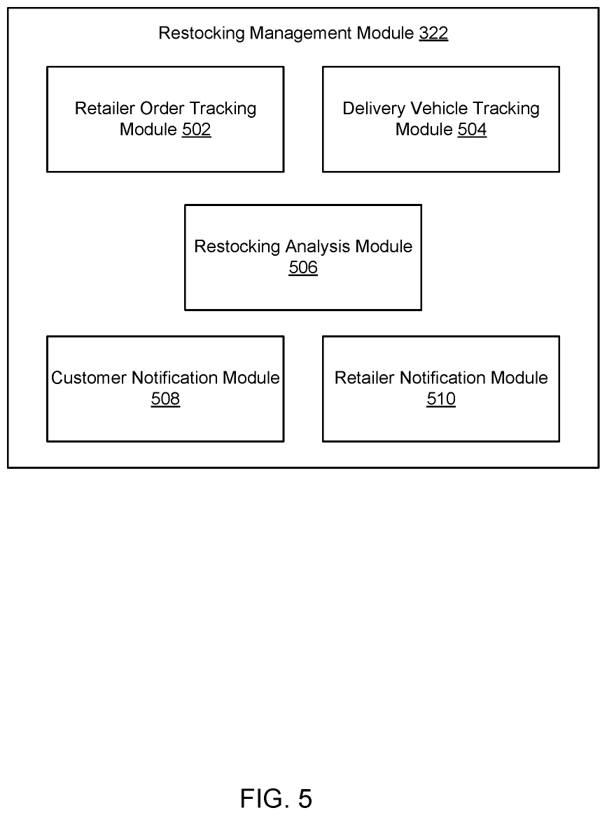

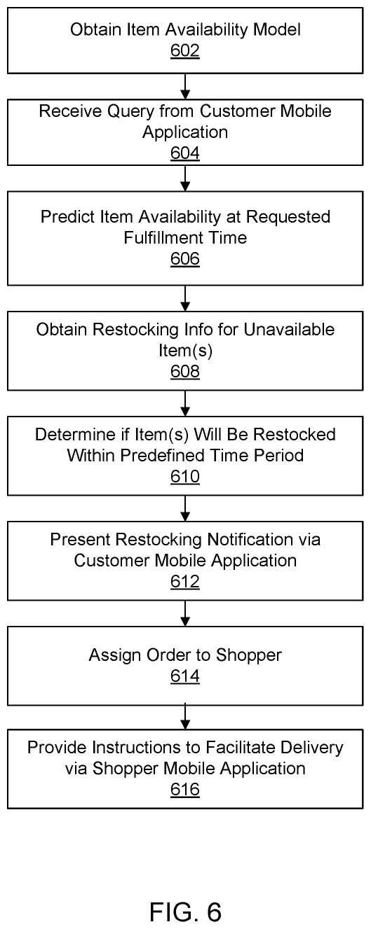

The restocking management engine 322 obtains and processes information relating to restocking of items at various warehouses and may deliver notifications to customers and/or retailers relevant to restocking information. For example, the restocking management engine 322 may obtain information relating to restocking orders placed by retailers, vehicle tracking information relating to vehicles enroute to retailers with items for restocking, item scanning information relating to times and locations of scanned items enroute to a retailer or between delivery and re-shelving, or other information relevant to determining if and when items will be restocked at retailers. The restocking management engine 322 may furthermore generate notifications to customers, shoppers, and/or retailers relating to restocking information. For example, responsive to receiving a search query from a customer for an item that is predicted to be unavailable, the restocking management engine 322 may determine, based on the restocking information, if the item is expected to be restocked in the near future and may present the customer with an opportunity to include the item in an order to be fulfilled upon restocking. The restocking management engine 322 may furthermore provide information to retailers relating to requests for restocking of unavailable items that may aid retailers in restocking decisions. Furthermore, the restocking management engine 322 may provide notifications to shoppers relating to items being restocked, e.g., if they are held for a customer at a special location prior to being re-shelved. An embodiment of a restocking management engine 322 is described in further detail with respect to FIGS. 5-6 below.

### Customer Mobile Application

FIG. 4A is a diagram of the customer mobile application (CMA) 206, according to one or more embodiments. The CMA 206 includes an ordering interface 402, which provides an interactive interface with which the user 104 can browse through and select items and place an order. The CMA 206 also includes a system communication interface 404 which, among other functions, receives inventory information from the online shopping concierge system 102 and transmits order information to the system 202. The CMA 206 also includes a preferences management interface 406 which allows the user 104 to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 108 to manually enter information describing an item (such as its serial number, SKU, quantity and/or weight) if a barcode is not available to be scanned. SMA 212 also includes a basket manager 422 which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424 which interacts with the online shopping concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

### Restocking Management Engine

FIG. 5 is a block diagram illustrating an example embodiment of a restocking management engine 322. The restocking management engine 322 includes a retailer order tracking module 502, a delivery vehicle tracking module 504, a restocking analysis module 506, a customer notification module 508, and a retailer notification module 510. In alternative embodiments, the restocking management engine 322 includes additional or different modules.

The retailer order tracking module 502 tracks wholesale orders made by retailers for items that will be added to the inventory (e.g., in the inventory database 304) of the online concierge system 102. The retailer order tracking module 502 may maintain tracking of, for example, product identifiers for ordered items, quantities of ordered items, expected delivery times for ordered items, or other information relating to restocking of items at a retailer participating in the online concierge system 102.

In some embodiments, the retailer order tracking module 502 may obtain the order tracking information by interfacing with an ordering system used by retailers to place restocking orders. For example, the retailer order tracking module 502 may include one or more application programming interfaces (APIs) that interface with the retailer ordering system to directly obtain order information, with permissions from the retailer. In some embodiments, the retailer order tracking module 502 may include logic to convert order tracking information obtained in different formats native to different retailer ordering systems to a common format used by the retailer order tracking module 502.

In another embodiment, retailers may share restocking order information with the online concierge system 102 through other channels. For example, retailers may share order information through a web service provided by the online concierge system 102 that may enable order sharing in various format such as spreadsheets, extensible markup language (XML) format, various database formats, text documents, or custom formats specified by the web service. The retailer order tracking module 502 may execute a conversion process to convert the received order information to a custom format used by the retailer order tracking module 502.

In another embodiment, the retailer order tracking module 502 may include a retailer ordering system to enable participating retailers to directly place restocking orders through the online concierge system 102. In the case, the order information may be directly tracked by the retailer order tracking module 502.

The delivery vehicle tracking module 504 tracks items in restocking orders from retailers while they are enroute to the retailers. For example, the delivery vehicle tracking module 504 may track locations of items based on scanning data from scans performed on the items at various stages of the delivery process. Here, items may be scanned, for example, when items are loaded onto specific delivery vehicles for delivery to retailers, when items are offloaded from the delivery vehicles, and/or when items are transported between vehicles. The scanning data may uniquely identify the items being scanned, the time of the scan, a location associated with the scan, or other information for tracking progress of restocking orders. The scanning data may be generated from various scanning technologies such as barcodes, QR codes, radio frequency identifier (RFID), devices, or other types of scanning technology. Alternatively, the scanning data may include content recognition data that recognizes items using image recognition technology.

The delivery vehicle tracking module 504 may furthermore track the locations of the delivery vehicles as they are enroute to the retailers. Here, the delivery vehicle tracking module 504 may obtain routing information associated with predefined routes of the delivery vehicles to the retailers and information regarding expected delivery times. The delivery vehicle tracking module 504 may furthermore obtain delivery exception information indicative of delivery delays, cancellations, rerouting, or other deviations from the predefined delivery route and schedule. Furthermore, the delivery vehicle tracking module 504 may obtain real-time location information based on global positioning system (GPS) data or other location tracking information associated with the delivery vehicles.

In some embodiments, the delivery vehicle tracking module 504 obtains the item scanning information and vehicle routing information by interfacing with item tracking and routing systems associated with the retailers and/or with delivery logistics providers. For example, the delivery vehicle tracking module 504 may include one or more APIs for directly interfacing with one or more different item tracking and routing systems that enables the delivery vehicle tracking module 504 to obtain relevant information. In another embodiment, the separate scanning systems operated by the online concierge system 102 may directly interface with the delivery vehicle tracking module 504. In this case, the scanning systems may operate in parallel with scanning and tracking systems operated by the retailers, suppliers, or logistics operators.

The restocking analysis module 506 determines an expected restocked availability time associated with items that are currently identified as unavailable (or predicted to be unavailable). The restocking analysis module 506 may determine the restocked availability time based on the retailer ordering information, the item scanning information, the vehicle tracking information, or a combination thereof. For example, in some embodiments, the restocked availability time may be based on an expected delivery time included in the item ordering information. In another embodiment, the restocked availability time may be based on vehicle routing information indicating a predicted delivery time based on the predefined routing information and/or the real-time tracking information. In a further embodiment, the restocked availability time may be determined from scanning information indicating that items have been loaded onto vehicles for delivery or offloaded at the retailer for restocking on shelves.

In some embodiments, the restocking analysis module 506 may determine the restocked availability time based in part on a predicted shelving time between the expected delivery time and the items becoming available for purchase at the retailer. Here, the shelving time may be set by the retailers or may be based on a machine learning model trained based on historical data. For example, the model may be based on observing a difference between the vehicle arrival times at the retailers and the item availability times.

The customer notification module 508 interacts with the customer mobile application 206 to provide information to customers relating to restocking of items. For example, in response to a search query relevant to an item predicted to be unavailable at a requested order fulfillment time, the customer notification module 508 may determine if the item is expected to be restocked in the near future. If restocking is expected within a predefined time window (e.g., the next few hours or within the same day), the customer notification module 508 may provide a notification to the customer via the customer mobile application 206 indicative of the expected restocked availability time. For example, the customer mobile application 206 may notify the customer that the item is currently unavailable but is expected to be restocked at a certain time or in a certain number of hours. In some embodiments, the customer notification module 508 may provide an option via the customer mobile application 206 to enable the customer to delay their order fulfillment time from the original requested time to a future time when the unavailable item is expected to be restocked.

In some embodiments, the customer notification module 508 may provide customer notifications relating to restocking of items independently of a specific search query. For example, a customer may subscribe to restocking notifications relating to certain hard to find items. These notifications may inform the customer of when the item is expected to become available at a retailer and enable advance purchase of the item prior to the item being available for purchase in the store.

In another embodiment, the customer notification module 508 may provide restocking information to a customer via the customer mobile application 206 in response to a specific request for restocking information. For example, the customer mobile application 206 may include a control element that enables a customer to request restocking information for an item shown as unavailable or predicted to be unavailable. If restocking information is available, the customer notification module 508 may then provide the expected or predicted restocking time responsive to the request.

In another embodiment, the customer notification module 508 may interact with a “restocking request” button in the customer mobile application 206 that allows a customer to request restocking of an unavailable item. Following such a request, the customer notification module 508 may notify the customer either directly through the customer mobile application 206 or via an external communication mechanism (e.g., a phone call, email, or text message) when the restocking information becomes available.

The retailer notification module 510 may facilitate communications with retailers relating to restocking of items. In some embodiments, the retailer notification module 510 may send a notification to a retailer when at least one customer (or other threshold number of customers) requests that an item be restocked (e.g., using the “restocking request” button in the customer mobile application 206). This information may enable a retailer to adjust their ordering process in response to expected customer demand. In a further embodiment, the online concierge system 102 may automatically facilitate restocking ordering decisions based on determined customer demand for out-of-stock items.

In another embodiment, the retailer notification module 510 may send a recommendation to a retailer that aids in prioritizing processing of incoming restocking deliveries based in part on consumer demand. For example, the retailer notification module 510 may determine that one or more pending orders includes an item that recently arrived or will soon arrive at the retailer, and may send a notification recommending that the retailer prioritize restocking of the requested item on the shelf. In some embodiments, a machine learning model may recommend a reshelving priority based on a historical model to maximize order fulfillment opportunities.

The retailer notification module 510 may furthermore provide a recommendation to set aside one or more items that has recently been delivered or will soon be delivered to enable pickup from a shopper before the item reaches the shelves. In some embodiments, a similar notification may be sent to a shopper mobile application 212 to alert the shopper that the item is set aside and where to locate the item.

In another embodiment, the retailer notification module 510 may provide an auditing function for a retailer by notifying the retailer of discrepancies between restocking orders and the items arriving at the retailer. For example, the retailer notification module 510 may compare information obtained relating to orders placed by the retailers, information from scanning data relating to enroute items, and information obtained at the retailer location relating to items that are arrived and being reshelved. The retailer notification module 510 may provide notifications relating to specific discrepancies and/or general trends observed over time.

FIG. 6 is a flowchart illustrating an example embodiment of a process for managing orders in an online concierge system 102. An item availability model is obtained 602 that is trained to predict availability likelihoods of items in an inventory of an online concierge system. A query is received 604 from a customer via the customer mobile application 206, for an item at a requested order fulfillment time. Based on the item availability model, the online concierge system 102 predicts 606 whether or not the item will be available at the requested order fulfillment time. Responsive to predicting that the item will not be available at the requested order fulfillment time, item tracking information is obtained 608 providing information about items that are in the restocking process (e.g., items that have been ordered by retailers, are enroute on delivery vehicles to retailers, or have arrived at retailers but have not yet been reshelved). Based on the item tracking information, the online concierge system 102 determines 610 if the item will be restocked at a future time within a predefined time period of the order fulfillment time (e.g., within the next few hours, within the same day, within 24 hours, etc.). Responsive to determining that the item will be restocked at the future time, the online concierge system 102 presents 612 a notification via the customer application in response to the query indicating that the item will be restocked at the future time and enabling the customer to order the item for the future time. To facilitate fulfillment of the order, the online concierge system 102 assigns 614 the order to an available shopper at an appropriate time, and provides 616 routing instructions via the shopper mobile application 212 for facilitating delivery by the shopper to the customer.

The described restocking management engine 322 and associated process beneficially enables opportunities to inform customers about the status of unavailable items and when such items are expected to be back in stock. This enables the online concierge system 102 to accept orders for items that are currently unavailable and/or make specific recommendations to customers about when such an order can be fulfilled. Incorporating such restocking information into the online concierge system 102 may therefore result in sales that may not otherwise occur while still providing customers with accurate item availability information.

### Additional Considerations

The foregoing description of the embodiments of the invention has been presented for the purpose of illustration; it is not intended to be exhaustive or to limit the invention to the precise forms disclosed. Many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
at a computer system comprising at least one processor and memory:
accessing an item availability model trained to predict availability likelihoods of items in an inventory of an online concierge system;
receiving from a customer device, via a customer application, a query for an item at a requested order fulfillment time;
predicting, based on the item availability model, that the item will not be available at the requested order fulfillment time in response to the query;
responsive to predicting that the item will not be available at the requested order fulfillment time, obtaining item tracking information indicating items enroute to retailers;
determining, based on the item tracking information, that the item will be restocked at a future time within a predefined time period of the requested order fulfillment time;
responsive to determining that the item will be restocked at the future time, presenting, via the customer application and in response to the query for the item, a notification indicating that the item will be restocked at the future time and enabling the customer application to generate an order that includes the item for fulfillment during the future time;
assigning the order to an available shopper; and
generating routing instructions via a shopper application for facilitating delivery by the available shopper to a location of a customer associated with the customer application.

2. The method of claim 1, wherein presenting the notification comprises:
presenting an option to delay the requested order fulfillment time until the future time when the item will be restocked; and
delaying the requested order fulfillment time in response to a selection of the option via the customer application.

3. The method of claim 1, wherein obtaining the item tracking information comprises obtaining at least one of:
order information from the retailers indicative of items ordered from the retailers,
delivery vehicle tracking data indicating tracked locations of delivery vehicles carrying the items ordered from the retailers,
delivery vehicle routing data indicating planned routes of the delivery vehicles to the retailers,
scanning data indicating times and locations where items have been scanned enroute to the retailers, and
a restocking time model indicative of time between delivery of the items by the delivery vehicles and restocking of the items by the retailers.

4. The method of claim 1, further comprising:
tracking a set of orders for a retailer associated with items predicted to be unavailable; and
generating a notification to the retailer indicative of the tracked set of orders.

5. The method of claim 4, wherein generating the notification to the retailer comprises:
generating a recommendation for how to prioritize unloading and restocking of items based on the tracked set of orders.

6. The method of claim 4, wherein generating the notification to the retailer comprises:
generating a recommendation to set aside one or more of the items for pickup without putting the items on shelves based on the tracked set of orders.

7. The method of claim 4, wherein generating the notification to the retailer comprises:
generating an audit report indicating whether the tracked set of orders is consistent with order information from one or more retailers.

8. A computer program product comprising a non-transitory computer-readable storage medium storing instructions that when executed by a processor cause the processor to perform steps including:
accessing an item availability model trained to predict availability likelihoods of items in an inventory of an online concierge system;
receiving from a customer device, via a customer application, a query for an item at a requested order fulfillment time;
predicting, based on the item availability model, that the item will not be available at the requested order fulfillment time in response to the query;
responsive to predicting that the item will not be available at the requested order fulfillment time, obtaining item tracking information indicating items enroute to retailers;
determining, based on the item tracking information, that the item will be restocked at a future time within a predefined time period of the requested order fulfillment time;
responsive to determining that the item will be restocked at the future time, presenting, via the customer application and in response to the query for the item, a notification indicating that the item will be restocked at the future time and enabling the customer application to generate an order that includes the item for fulfillment during the future time;
assigning the order to an available shopper; and
generating routing instructions via a shopper application for facilitating delivery by the available shopper to a location of a customer associated with the customer application.

9. The computer program product of claim 8, where presenting the notification comprises:
presenting an option to delay the requested order fulfillment time until the future time when the item will be restocked; and
delaying the requested order fulfillment time in response to a selection of the option via the customer application.

10. The computer program product of claim 8, wherein obtaining the item tracking information comprises obtaining at least one of:
order information from the retailers indicative of items ordered from the retailers,
delivery vehicle tracking data indicating tracked locations of delivery vehicles carrying the items ordered from the retailers,
delivery vehicle routing data indicating planned routes of the delivery vehicles to the retailers,
scanning data indicating times and locations where items have been scanned enroute to the retailers, and
a restocking time model indicative of time between delivery of the items by the delivery vehicles and restocking of the items by the retailers.

11. The computer program product of claim 8, the instructions when executed further causing the processor to perform steps including:
tracking a set of orders for a retailer associated with items predicted to be unavailable; and
generating a notification to the retailer indicative of the tracked set of orders.

12. The computer program product of claim 11, wherein generating the notification to the retailer comprises:
generating a recommendation for how to prioritize unloading and restocking of items based on the tracked set of orders.

13. The computer program product of claim 11, wherein generating the notification to the retailer comprises:
generating a recommendation to set aside one or more of the items for pickup without putting the items on shelves based on the tracked set of orders.

14. The computer program product of claim 11, wherein generating the notification to the retailer comprises:
generating an audit report indicating whether the tracked set of orders is consistent with order information from one or more retailers.

15. A computer system comprising:
a processor; and
a non-transitory computer-readable storage medium storing instructions that when executed by the processor cause the processor to perform steps including:
accessing an item availability model trained to predict availability likelihoods of items in an inventory of an online concierge system;
receiving from a customer device, via a customer application, a query for an item at a requested order fulfillment time;
predicting, based on the item availability model, that the item will not be available at the requested order fulfillment time in response to the query;
responsive to predicting that the item will not be available at the requested order fulfillment time, obtaining item tracking information indicating items enroute to retailers;
determining, based on the item tracking information, that the item will be restocked at a future time within a predefined time period of the requested order fulfillment time;
responsive to determining that the item will be restocked at the future time, presenting, via the customer application and in response to the query for the item, a notification indicating that the item will be restocked at the future time and enabling the customer application to generate an order that includes the item for fulfillment during the future time;
assigning the order to an available shopper; and
generating routing instructions via a shopper application for facilitating delivery by the available shopper to a location of a customer associated with the customer application.

16. The computer system of claim 15, where presenting the notification comprises:
presenting an option to delay the requested order fulfillment time until the future time when the item will be restocked; and
delaying the requested order fulfillment time in response to a selection of the option via the customer application.

17. The computer system of claim 15, wherein obtaining the item tracking information comprises obtaining at least one of:
order information from the retailers indicative of items ordered from the retailers,
delivery vehicle tracking data indicating tracked locations of delivery vehicles carrying the items ordered from the retailers,
delivery vehicle routing data indicating planned routes of the delivery vehicles to the retailers,
scanning data indicating times and locations where items have been scanned enroute to the retailers, and
a restocking time model indicative of time between delivery of the items by the delivery vehicles and restocking of the items by the retailers.

18. The computer system of claim 15, the instructions when executed further causing the processor to perform steps including:
tracking a set of orders for a retailer associated with items predicted to be unavailable; and
generating a notification to the retailer indicative of the tracked set of orders.

19. The computer system of claim 18, wherein generating the notification to the retailer comprises:
generating a recommendation for how to prioritize unloading and restocking of items based on the tracked set of orders.

20. The computer system of claim 18, wherein generating the notification to the retailer comprises:
generating a recommendation to set aside one or more of the items for pickup without putting the items on shelves based on the tracked set of orders.
